(19) United States
(12) Patent Application Publication
(10) Pub. No.: US 2019/0133301 A1
(43) Pub. Date: May 9, 2019

(54) Non-Surgical Anti-Aging Denture Facelift System

(71) Applicant: Vahid Dan Danaei-Moghaddam, Vaughan (CA)

(72) Inventor: Vahid Dan Danaei-Moghaddam, Vaughan (CA)

(21) Appl. No.: 15/807,571

(22) Filed: Nov. 8, 2017

(51) Int. Cl. A45D 44/22; A61C 13/00; A61C 13/07; A61C 13/01

(52) U.S. Cl. CPC A45D 44/22; A61C 13/01; A61C 13/0025; A61C 13/0004

(57) ABSTRACT

An apparatus and process whereby bite registration is used in the process of making removable or fixed over-implant dentures that makes patients look younger without plastic surgery. Various combinations of dentures may be used. The denture face lift system improves the ‘look’ of virtually all or part of facial defects or aging wrinkles by opening proper vertical dimension in max, leaving at least 3 mm free way space between maxillary (upper) & mandibular (lower) teeth, for proper mastication and providing a proper (fuller) lip and chick support, which improves appearance and smile lines as called Anti-Aging.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of anti-aging means of existing art and more specifically relates to a denture facelift system.

### RELATED ART

Dentures, (false teeth), are prosthetic devices constructed to replace missing teeth; as conventionally manufactured they are supported by the surrounding soft and hard tissues of the oral cavity when worn. Conventional dentures are removable as a removable partial denture or complete denture. However, there are many denture designs, some which rely on bonding or clasping onto teeth or dental implants known as fixed prosthodontics. There are two main categories of dentures, the distinction being whether they are used to replace missing teeth on the mandibular arch or on the maxillary arch.

Many individuals in modern society are concerned with their aesthetic appearance and strive to look young despite age taking a toll on their face and body. Many individuals look to cosmetic surgery to make desired aesthetic changes to various body parts; plastic surgery may be dangerous. As we age, our teeth and gums also tend to recede into the mouth. This movement of the teeth causes additional wrinkling around the mouth area as the skin folds sag without support, a condition which is exaggerated with the loss of skin elasticity. Many individuals would like to look young yet not compromise health to do so. thus, a suitable, affordable, non-invasive solution is desired.

U.S. Pub. No. 2006/0172262 to Craig Bruce relates to cosmetic prosthesis and methods for making the same. The described cosmetic prosthesis and methods for making the same includes a cosmetic prosthesis designed to provide non-invasive, removable enhancement of upper and lower lip, being intended to contour and push the facial skin around the mouth and jaw outward, reducing the appearance of wrinkles or aging lines.

### SUMMARY OF THE INVENTION

In view of the foregoing disadvantages inherent in the known anti-aging means art, the present disclosure provides a novel denture facelift system (DFS). The general purpose of the present disclosure, which will be described subsequently in greater detail, is to provide an effective and efficient denture facelift system that opens the mouth to proper vertical dimensions such that proper skin tension and support is maintained.

A denture facelift system is disclosed herein in a preferred embodiment, this denture facelift system comprising: a denture facelift assembly including an upper-denture; and a lower denture; wherein the denture facelift system comprises the denture facelift assembly. The denture facelift assembly preferably includes in functional combination the upper-denture, and the lower denture that are extended at at least one gum section (top and/or bottom or combination thereof; may include extension of length or thickness of gum. following requirements of denture making and teeth setup standards) such that a free-way space is left of at least 3 mm between (upper) maxillary and (lower) mandibular teeth to allow for proper mastication to occur. Other dimensions may be used. As designed, the denture facelift assembly is supported by surrounding soft and hard tissues of an oral cavity of a user-wearer, when worn, and when installed are configured to maintain desired vertical placement of face-structure of the user-wearer.

A denture facelift system in an alternate embodiment is also disclosed herein, this denture facelift system comprising: a denture facelift assembly including a dental prosthetic appliance; wherein the denture facelift system comprises the denture facelift assembly. The denture facelift assembly in this particular embodiment comprises the dental prosthetic appliance allowing, when inserted, an extension via at least one gum section such that a free-way space is left of at least 3 mm between maxillary and mandibular teeth to allow for proper mastication to occur. Similar to the above embodiment the denture facelift assembly is supported by surrounding soft and hard tissues of an oral cavity of a user-wearer, when worn, and when installed are configured to maintain desired vertical placement of face-structure of the user-wearer. As such a combination of partial or complete upper or lower (or both upper and lower dentures, removable or fixed, standard or implant supported dentures) involving the bite registration process and teeth set up open a vertical dimension and more or less adding the height and the thickness of the flange (gum) if necessary to create the desired orientation effect described herein.

The denture facelift system includes a method of making and using a denture facelift system. The method comprises the steps of: providing a denture facelift system, the denture facelift system comprising: a denture facelift assembly including at least an upper-denture; and (optionally) a lower denture (or combinations thereof); the denture facelift assembly prepared by registering a user-wearer-bite using bite blocks, measurement tools, and bite-register-material; and installing the denture facelift assembly when completed for use. The method of use may further comprise the steps of filling required zones with wax as needed and adjusting and correcting as necessary for achieving a comfortable fit.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a denture facelift system, constructed and operative according to the teachings of the present disclosure.

FIG. 1 is a perspective view of the denture facelift system during an ‘in-use’ condition, according to an embodiment of the disclosure.

FIG. 2 is a perspective view of the denture facelift system of FIG. 1, according to an embodiment of the present disclosure.

FIG. 3 is a perspective view of the denture facelift system of FIG. 1, according to an embodiment of the present disclosure.

FIG. 4 is a perspective view of the denture facelift system of FIG. 1, according to an embodiment of the present disclosure.

FIG. 5 is a flow diagram illustrating a method of use for the denture facelift system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an anti-aging (by appearance) means and more particularly to a denture facelift system as used to improve the facial look and tone of a user-wearer.

Generally speaking, the present invention is a combination of partial or complete upper or lower or both upper and lower dentures involving the bite registration process and teeth set up to open a vertical dimension and more or less add the height and the thickness of the flange (gum) if necessary to provide the described function. The denture face lift system will improve virtually all or part of facial defects or aging wrinkles by opening proper vertical dimension in max, leaving at least 3 mm free way space between maxilla & mandible teeth, for proper mastication.

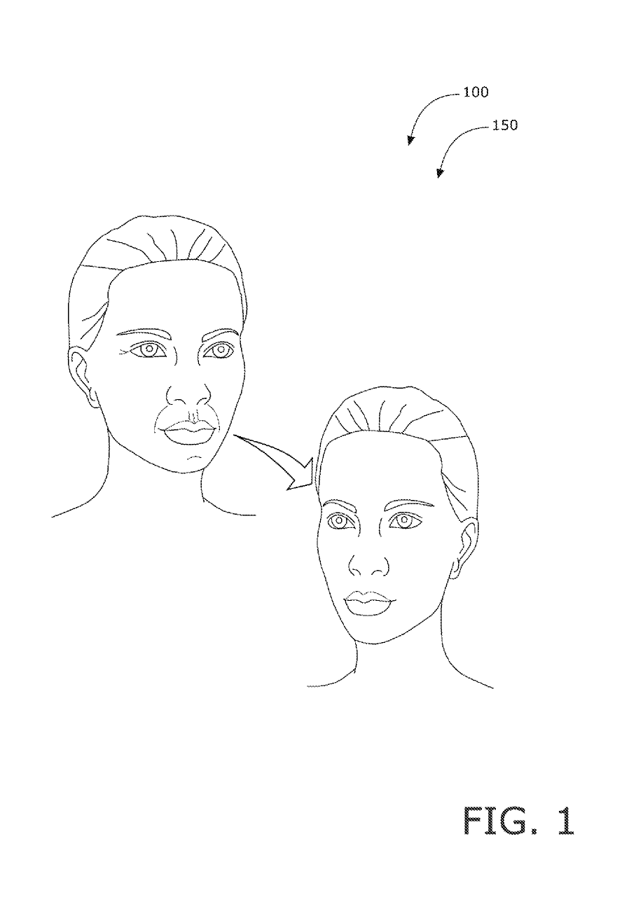

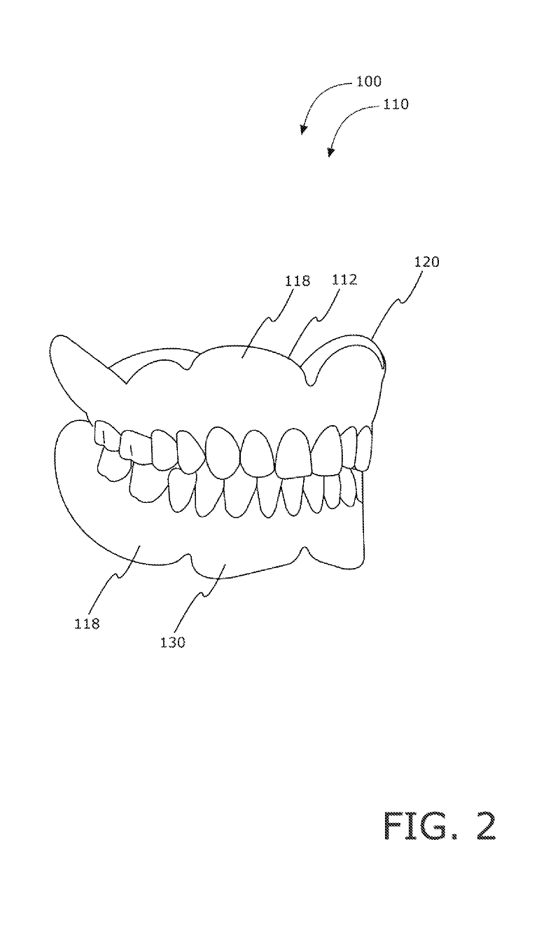

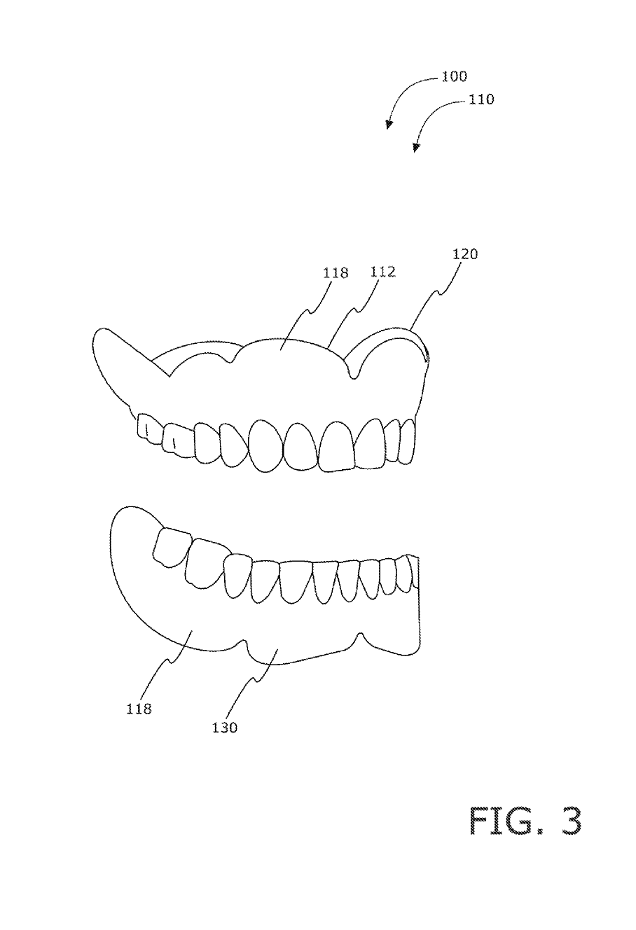

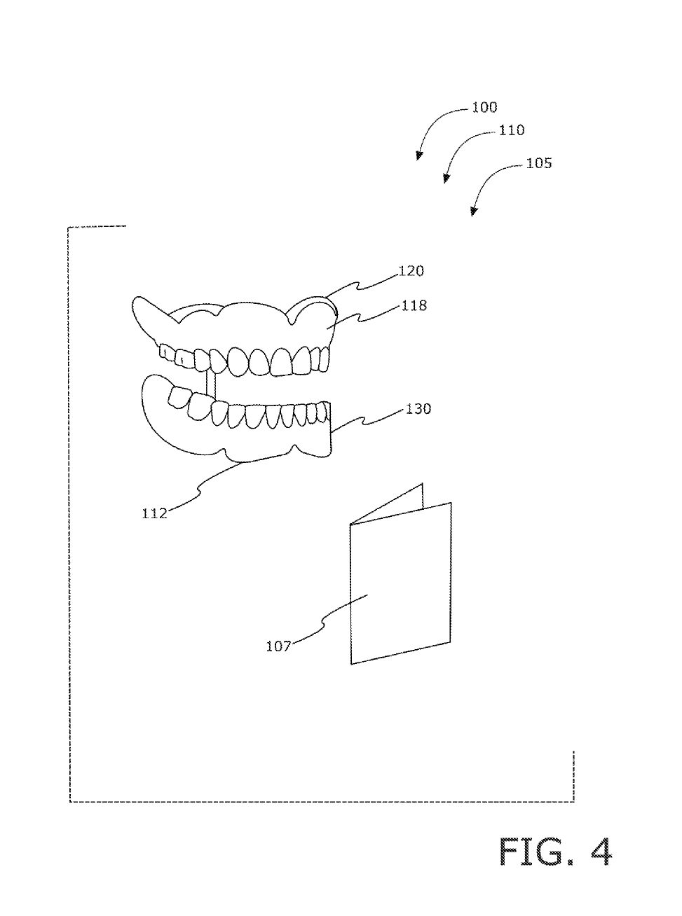

Referring now more specifically to the drawings by numerals of reference, there is shown in FIGS. 1-4, various views of a denture facelift system 100.

FIG. 1 shows a denture facelift system 100 during an ‘in-use’ condition 50, according to an embodiment of the present disclosure. Here, the denture facelift system 100 may be beneficial for use by a user 40 to promote proper facial orientation. As illustrated, the denture facelift system 100 may include a denture facelift assembly 110 including an upper-denture 120; and a lower denture 130; as such the denture facelift system 100 comprises the denture facelift assembly 110. The denture facelift assembly 110 includes in functional combination the upper-denture 120, and the lower denture 130 that are extended at at least one gum section 118 such that a free-way space is left of at least 3 mm between maxillary and mandibular teeth to allow for proper mastication to occur; and as designed the denture facelift assembly 110 is supported by surrounding soft and hard tissues of an oral cavity of a user-wearer 140, when worn, and when installed are configured to maintain desired vertical placement of face-structure of the user-wearer 140.

The denture facelift assembly 110 is formed via a bite registration process, as discussed in the method of use. Those with ordinary skill in the art will now appreciate that upon reading this specification and by their understanding the art of teeth care, building and dentures as described herein, methods of creating bite registration will be understood by those knowledgeable in such art. The at least one gum section 118 is extended in height to achieve desired the free-way space; wherein the at least one gum section 118 is able to be extended (in manufacturing) in thickness to achieve desired free-way space for the individual user-wearer 140. When generally referring to the face-structure of the user-wearer 140 the face-structure comprises skin, the skin caused to be taut, as desired; also referring to muscle(s), the muscles caused to be oriented in a proper vertical-positioning and horizontal-positioning. Further, bone-structure is orientated in relation to the face. The upper-denture referred to herein may be a partial or full; the lower-denture may be a partial or full or combination thereof.

According to one embodiment, the denture facelift system 100 may be arranged as a kit 105. In particular, the denture facelift system 100 may further include a set of instructions 107. The instructions 107 may detail functional relationships in relation to the structure of the denture facelift system 100 such that the denture facelift system 100 can be used, maintained, or the like, in a preferred manner. The system involves new line of high precision Impression, clinical, in-lab and processing materials and products. a package that includes Instruction of method and a kit of tools including bite registration and high precision measuring tools, high precision DFS (Denture Facelift System) Teeth size, shade & shape, sets of in lab material and adjustment tools suitable for DFS.

In an alternate embodiment the denture facelift system 100 may comprise: a denture facelift assembly 110 including; a dental prosthetic appliance 112; wherein the denture facelift system 100 comprises the denture facelift assembly 110 and the denture facelift assembly 110 comprises the dental prosthetic appliance 112 allowing, (when inserted), an extension via at least one gum section 118 such that a free-way space is left of at least 3 mm between maxilla and mandible teeth to allow for proper mastication to occur. The denture facelift assembly 110 is supported by surrounding soft and hard tissues of an oral cavity of a user-wearer 140, when worn, and when installed are configured to maintain desired vertical placement of face-structure of the user-wearer 140.

The dental prosthetic appliance 112 comprises only an upper-denture 120 in certain embodiments and only a lower-denture 130 in other embodiments or may comprise an upper-denture 120 and a lower-denture 130 in functional combination in other embodiments. The extension via the at least one gum section 118 is achieved via a height-increase and/or a thickness-increase (height-increase and a thickness-increase in combination).

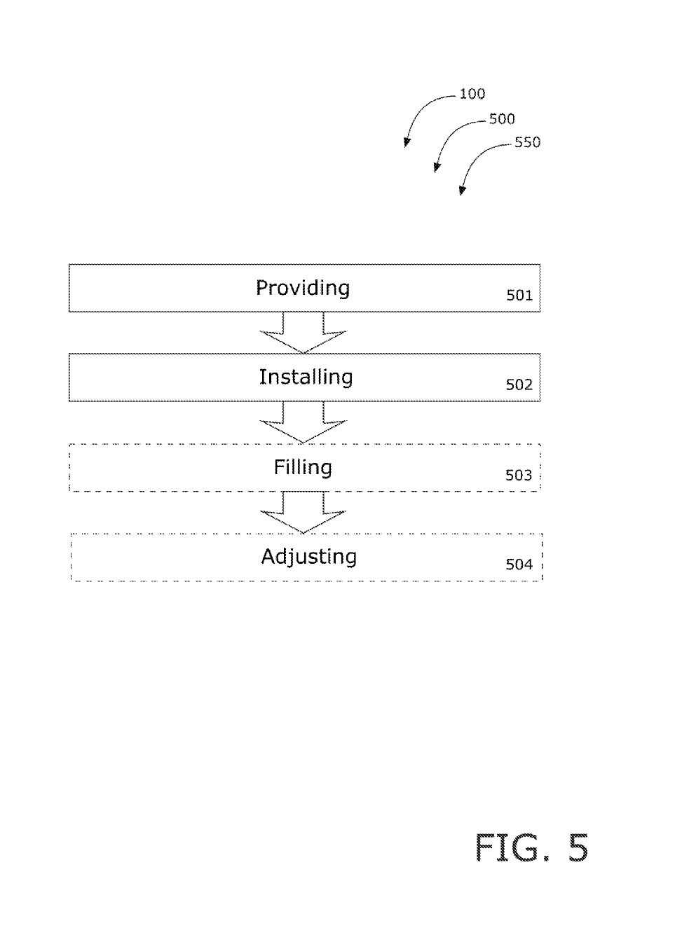

Referring now to FIG. 5 showing a flow diagram illustrating a method 500 for making/use of the denture facelift system 100, according to an embodiment of the present disclosure. In particular, the method 500 for denture facelift system 100 may include one or more components or features of the denture facelift system 100 as described above. As illustrated, the method of use 500 may include the steps of: step one 501, providing a denture facelift system, the denture facelift system comprising: a denture facelift assembly including an upper-denture; and optionally a lower denture; step two 502, preparing the denture facelift assembly (prepared by registering a user-wearer-bite using bite blocks, measurement tools, and bite-register-material), as understood by those specialized in the art; step three 503, installing the denture facelift assembly when completed for temporary use as try in model; and step four 504 filling required zones with wax as needed and adjusting and correcting as necessary for achieving a comfortable fit and try in acceptance for final processing of prosthetics. Those with ordinary skill in the art will now appreciate that upon reading this specification and by their understanding the art of providing bite registration and other services by dental providers, dental clinics, dental labs, and professional as described herein, methods of registering, fitting, adjusting, maintaining, processing and the like will be understood by those knowledgeable in such art.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for enhancing skin look and proper facial positioning via the denture facelift system 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A denture facelift system, the denture facelift system comprising:
a denture facelift assembly including;
an upper-denture; and
a lower denture;
wherein said denture facelift system comprises said denture facelift assembly;
wherein said denture facelift assembly includes in functional combination said upper-denture, and said lower denture that are extended at at least one gum section such that a free-way space is left of at least 3 mm between maxillary and mandibular teeth to allow for proper mastication to occur; and
wherein said denture facelift assembly is supported by surrounding soft and hard tissues of an oral cavity of a user-wearer, when worn, and when installed are configured to maintain desired vertical placement of face-structure of said user-wearer.

2. The denture facelift system of claim 1, wherein said denture facelift assembly is formed via a bite registration process teeth setup and fuller lip and chick support.

3. The denture facelift system of claim 1, wherein said at least one gum section is extended in height to achieve desired said free-way space.

4. The denture facelift system of claim 1, wherein said at least one gum section is extended in thickness to achieve desired said free-way space.

5. The denture facelift system of claim 1, wherein the face-structure of said user-wearer comprises skin, said skin caused to be taut.

6. The denture facelift system of claim 1, wherein said face-structure of said user-wearer comprises muscle(s), said muscles caused to be oriented in a proper vertical-positioning and horizontal-positioning.

7. The denture facelift system of claim 1, wherein the upper-denture is a partial.

8. The denture facelift system of claim 1, wherein the lower-denture is a partial.

9. The denture facelift system of claim 1, wherein the upper-denture is full.

10. The denture facelift system of claim 1, wherein the lower-denture is full.

11. A denture facelift system, the denture facelift system comprising:
a denture facelift assembly including;
a dental prosthetic appliance;
wherein said denture facelift system comprises said denture facelift assembly;
wherein said denture facelift assembly comprises said dental prosthetic appliance allowing, when inserted, an extension via at least one gum section such that a free-way space is left of at least 3 mm between maxillary (Upper) and mandibular (Lower) teeth to allow for proper mastication to occur; and
wherein said denture facelift assembly is supported by surrounding soft and hard tissues of an oral cavity of a user-wearer, when worn, and when installed are configured to maintain desired vertical placement of face-structure of said user-wearer.

12. The denture facelift system of claim 11, wherein the dental prosthetic appliance comprises only an upper-denture.

13. The denture facelift system of claim 11, wherein the dental prosthetic appliance comprises only a lower-denture.

14. The denture facelift system of claim 11, wherein the dental prosthetic appliance comprises an upper-denture and a lower-denture in functional combination.

15. The denture facelift system of claim 11, wherein the extension via said at least one gum section is achieved via a height-increase.

16. The denture facelift system of claim 11, wherein the extension via said at least one gum section is achieved via a thickness-increase.

17. The denture facelift system of claim 15, wherein the extension via said at least one gum section is achieved via said height-increase and a thickness-increase in combination.

18. The denture facelift system of claim 17, further comprising set of instructions; and
wherein the denture facelift system is arranged as a kit which improves appearance and smile lines as called ‘Anti-Aging’.

19. A method of making and using a denture facelift system, the method comprising the steps of:
providing a denture facelift system, the denture facelift system comprising:
a denture facelift assembly including;
an upper-denture; and
a lower denture;
said denture facelift assembly prepared by registering a user-wearer-bite using bite blocks, measurement tools, and bite-register-material; try in, processing; and
installing said denture facelift assembly when completed for use.

20. The method of claim 19, further comprising the steps of filling required zones with wax as needed and adjusting and correcting as necessary for achieving a comfortable fit for final process of prosthetics in dental lab.
